(19) United States
(12) Patent Application Publication
(10) Pub. No.: US 2006/0232878 A1
(43) Pub. Date: Oct. 19, 2006

(54) Disk device

(75) Inventor: Kengo Saruta, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/402,993

(22) Filed: Apr. 13, 2006

(30) Foreign Application Priority Data
Apr. 13, 2005 (JP) 2005-115995

(51) Int. Cl. G11B 17/00

(52) U.S. Cl. 360/97.01

(57) ABSTRACT

According to one embodiment, a disk device includes an open-topped, plate-like base, a plate-like top cover which is attached to the base and closes a top opening, a printed circuit board provided opposite the base on the reverse side thereof, and a plate-like bottom cover which covers the reverse side of the printed circuit board and the base. Provided on the base are a disk-shaped recording medium and a mechanical section which includes a head for processing information on the recording medium, a head actuator supporting the head, and a drive motor which supports and rotates the recording medium. The printed circuit board has a projection and an electronic component mounted in the notch portion by being at least partially dropped therein. The base has projections which project on the printed circuit board side and engage and support the electronic component.

### CROSS-REFERENCE TO RELATED APPLICATIONS

This application is based upon and claims the benefit of priority from Japanese Patent Application No. 2005-115995, filed Apr. 13, 2005, the entire contents of which are incorporated herein by reference.

### BACKGROUND

1. Field

One embodiment of the present invention relates to a disk device, and more particularly, to a card-shaped disk device.

2. Description of the Related Art

In recent years, disk devices, such as magnetic disk devices, optical disk devices, etc., have been widely used as external recording devices of computers or image recording devices. A thin card-shaped device is proposed as an example of the magnetic disk device that can be loaded into a card slot of a personal computer, for instance.

The card-shaped magnetic disk devices of this type must be made thinner and smaller than conventional magnetic disk devices. In one such disk device, therefore, various components are mounted on a plate-like base, and the top side of the base and the components are covered by a plate-like base that is attached to the base. In an arrangement described in Jpn. Pat. Appln. KOKAI Publication No. 2003-22634, for example, a printed circuit board for controlling the operation of the magnetic disk device is provided on the reverse side of the base, and it is covered by a bottom cover. An interface (I/F) connector for connecting the disk device to an external electronic device is mounted on one end part of the circuit board.

Among the electronic components mounted on the printed circuit board, the I/F connector is one of relatively bulky or thick components and hinders reduction in thickness of the magnetic disk device. Accordingly, there is proposed a disk device in which a printed circuit board is provided with a notch, and an I/F connector is mounted by being dropped in the notch. If the I/F connector is drop-mounted in this manner, the thickness of the entire device can be reduced by a margin equal to the thickness of the circuit board.

If the I/F connector is drop-mounted on the printed circuit board in order to reduce the device thickness, however, an external force, if any, that is applied to the I/F connector or the circuit board acts directly on a junction of the connector. Possibly, therefore, the connector itself or its junction may be cracked or broken. In such a case, it is hard to connect the magnetic disk device securely to an external device, so that the reliability of the device lowers considerably.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view showing the top side of a hard disk drive (hereinafter, referred to as an HDD) according to an embodiment of the invention;

FIG. 2 is an enlarged perspective view showing a reverse-side end part of the HDD;

FIG. 3 is a plan view of the HDD with its top cover off;

FIG. 4 is an exploded perspective view of the HDD;

FIG. 5 is an exploded perspective view showing the reverse side of the HDD;

FIG. 6 is a sectional view of a printed circuit board taken along line B-B of FIG. 4; and

FIG. 7 is a sectional view of the HDD taken along line A-A of FIG. 1.

### DETAILED DESCRIPTION

Various embodiments according to the invention will be described hereinafter with reference to the accompanying drawings. In general, according to one embodiment of the invention, a disc device comprises: a base; a disk-shaped recording medium provided on the base; a mechanical section provided on the base and including a head which processes information on the recording medium, a head actuator supporting the head, and a drive motor which supports and rotates the recording medium; and a printed circuit board which is provided opposite the base on a reverse side thereof and has a notch portion and an electronic component mounted in the notch portion by being at least partially dropped therein, the base having a projection which projects on the printed circuit board side and engages and supports the electronic component.

An embodiment in which this invention is applied to an HDD will now be described in detail with reference to the accompanying drawings.

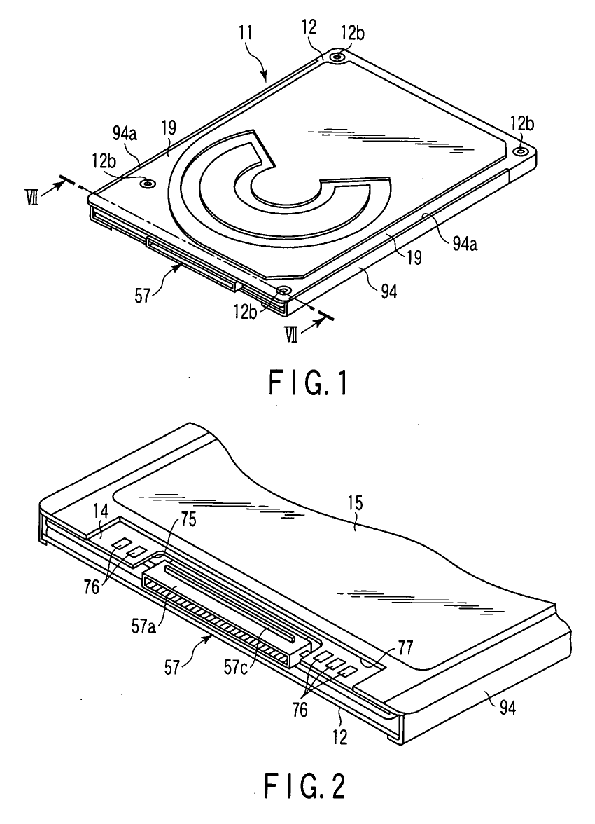

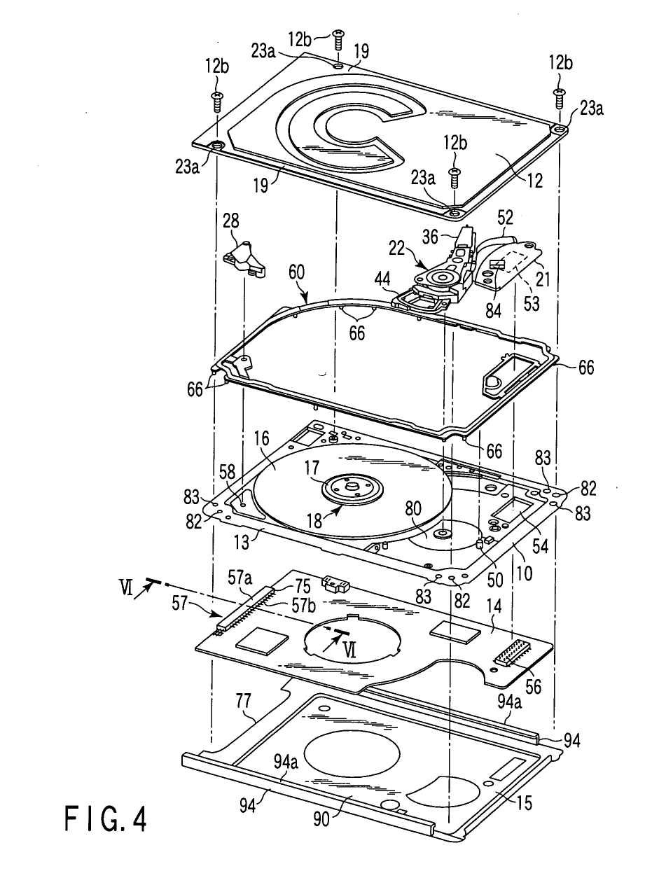

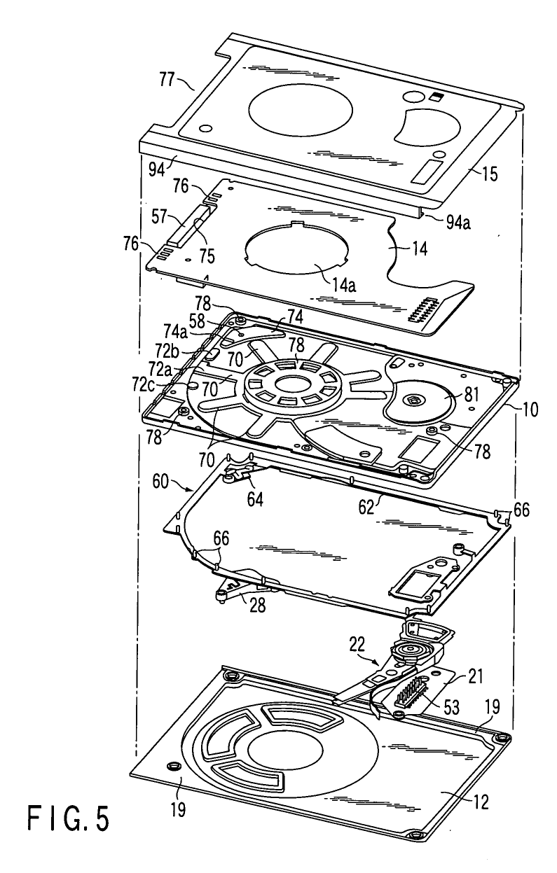

FIG. 1 shows the entire HDD from the top cover side, FIG. 2 is an enlarged view partially showing the bottom cover side of the HDD, and FIGS. 4 and 5 are exploded perspective views of the HDD. The HDD is card-shaped, as shown in FIGS. 1, 4 and 5, and is formed in conformity to standards for the PC card type, for example. The HDD has a base 10 in the form of a rectangular plate. The base 10 has recesses in which various members (mentioned later) are mounted, and its top side is open. The HDD comprises a plate-like top cover 12 that closes a top opening of the base 10, a printed circuit board 14 on the reverse side of the base, and a bottom cover 15 that covers the reverse side of the circuit board and the base. These elements are stacked in layers to form a card-shaped structure as a whole. The base 10, top cover 12, and bottom cover 15 constitute a flat, rectangular case 11.

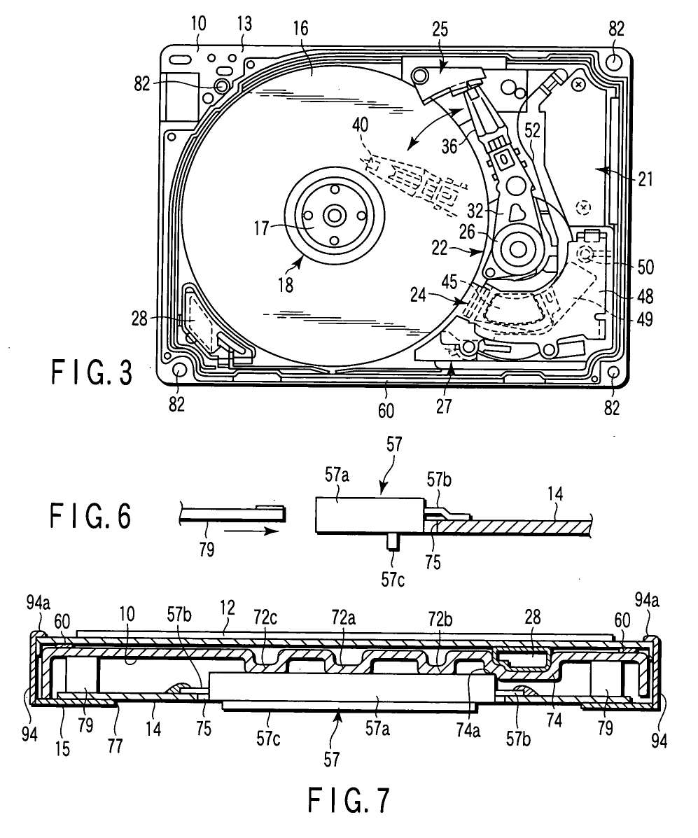

Mounted on the base 10, as shown in FIGS. 3 and 4, are a mechanical section and a magnetic disk 16 of, for example, 1.8-inch diameter, which serves as an information recording medium. The mechanical section comprises a spindle motor 18, magnetic heads 40, head actuator 22, voice coil motor (VCM) 24, ramp load mechanism 25, and inertia latch mechanism 27. The spindle motor 18 serves as a drive mechanism for supporting and rotating the magnetic disk 16. The magnetic heads 40 write in and read information from the disk 16. The head actuator 22 supports the magnetic heads for movement with respect to the disk 16. The VCM 24 rotates and positions the head actuator. The ramp load mechanism 25 holds the magnetic heads in a position off the magnetic disk when the heads are moved to the outermost periphery of the disk. The inertia latch mechanism 27 holds the head actuator in a retreated position. A substrate unit 21, having a head IC and the like, and a pack-shaped air filter 28 are provided on the base 10.

The base 10 is formed by press-molding a soft magnetic material, e.g., an iron-based material such as a cold-rolling carbon steel sheet (or steel plate cold commercial [SPCC]), and its peripheral edge portion forms a substantially flat abutting portion 13. Tapped holes 82 through which the top cover 12 is fixed with screws and positioning holes 83 for positioning a gasket 60 (mentioned later) are formed in the abutting portion 13 of the base 10.

A receiving portion (not shown) in which a bearing of the spindle motor 18 is to be fitted is set upright on the bottom surface of the base 10. The receiving portion is surrounded by an annular recess for holding coils of the spindle motor. This recess defines a projection 78 that projects on the reverse side of the base 10. A plurality of recesses extend radially from the annular recess and individually define ribs 70 or elongate projections that project on the reverse side of the base 10. A substantially circular recess 80 to be mounted with a bearing assembly 26 (mentioned later) of the head actuator 22 is formed on the bottom surface of the base 10. This recess defines a projection 81 that projects on the reverse side of the base.

A plurality of supporting projections that support an I/F connector 57 (mentioned later) mounted on the printed circuit board 14 are formed near one longitudinal end part of the bottom surface of the base 10, that is, near that short side on which the magnetic disk 16 is located. As shown in FIGS. 5 and 7, these projections include a first supporting projection 72a, which is formed by extending the distal end part of one of the ribs 70, and second and third supporting projection 72b and 72c on either side of the first supporting projection. The first supporting projection 72a is situated substantially on a longitudinal central axis of the base 10, while the second and third supporting projection 72b and 72c are situated side by side with the first supporting projection along the short-side direction of the base 10. The first, second, and third supporting projection 72a, 72b and 72c are formed integrally with the base 10 by press-molding the base. The first to third supporting projection 72a to 72c are equal in height, and their respective projected ends form a flat surface each.

Further, a recess for storing a part of the air filter 28 is formed in the bottom surface of the base 10. This recess defines a projection 74 that projects on the reverse side of the base. The projection 74 is provided at a corner portion of the base 10 on that side where the magnetic disk 16 is located, and is situated side by side with the second supporting projection 72b. The projection 74 is higher than the first to third supporting projection 72a to 72c. That end part of the projection 74 which adjoins the second supporting projection 72b is formed as a step portion 74a that is lower than the other portion. The step portion 74a is equal to the second supporting projection 72b in height and situated flush with the projected end of the second supporting projection.

As shown in FIGS. 3 and 4, the spindle motor 18 comprises a plurality of coils (not shown) mounted in the recess of the base 10, a spindle rotatably supported by the bearing fitted in the receiving portion of the base, and a hub formed integrally with the spindle. The magnetic disk 16 is fitted integrally on the upper end part of the hub and held by a clamp spring 17. The disk 16 is rotated at a given speed by the motor 18.

The head actuator 22 comprises the bearing assembly 26 fixed in the recess 80 of the base 10, two arms 32 extending from the bearing assembly, magnetic head assemblies 36 extending individually from the respective distal ends of the arms, and a support frame 44. The frame 44 extends from the bearing assembly in the direction opposite from the arms 32 and supports a voice coil. Each magnetic head assembly 36 includes a suspension in the form of an elongate plate and each magnetic head 40 that is fixed to the distal end of the suspension by a gimbals portion (not shown).

When the head actuator 22 is incorporated in the base 10, the magnetic disk 16 is situated between the two arms 32. The paired magnetic heads 40 are opposed individually to the upper and lower surfaces of the disk 16. Each head 40 is subjected to a given head load toward the disk surface by the spring force of the suspension.

The VCM 24 for rotating the head actuator 22 comprises a voice coil 45 fixed to the support frame 44 of the head actuator, an upper yoke 48 provided on the base 10 so as to face the voice coil, and a magnet 49 fixed on the inner surface of the upper yoke and opposed to the voice coil. The base 10, which is formed of a magnetic material, serves also as a lower yoke of the VCM 24.

When the voice coil 45 is energized, the head actuator 22 rotates between the retreated position indicated by full line in FIG. 3 and an operating position on the magnetic disk 16. In the operating position, each magnetic head 40 is positioned on a desired track of the disk 16. A stopper pin 50 set up on the base 10 restrains the head actuator 22 from excessively rotating beyond the retreated position.

As shown in FIGS. 3 to 5, each magnetic head 40 is connected electrically to the substrate unit 21 by a flexible cable 52. The substrate unit 21 is formed of a flexible printed circuit board, and a connector 53 for connection with the printed circuit board 14 is mounted on its bottom surface. The substrate unit 21 is screwed to the base 10, and the connector 53 faces a rectangular signal line passage opening 54 in the base 10. A shock sensor 84 for detecting a shock that acts on the HDD is mounted on the upper surface of the substrate unit 21.

A vent hole 58 for communication between the inside and outside of the base 10 is formed in one corner portion of the recess of the base. The air filter 28 is located in the recess (projection 74) so as to face the vent hole. The vent hole 58 serves to eliminate a difference between pressures inside and outside the base 10. As this is done, the air filter 28 prevents external dust or the like from penetrating the device.

As shown in FIGS. 4 and 5, the printed circuit board 14 on the reverse side of the base 10 has the shape of a rectangle that is a little smaller than the base. A plurality of electronic components including a connector 56 are mounted on one surface of the circuit board 14. The connector 56 is connected to the connector 53 on the substrate unit 21 in the base 10 through the signal line passage opening 54 of the base.

Further, the I/F connector 57 for connecting the HDD to an external device is drop-mounted as an electronic component on the printed circuit board 14. More specifically, as shown in FIGS. 2, 4, 5, 6 to 7, an elongate, rectangular notch portion 75 that opens in a short side of the circuit board 14 and extends along the short side is formed at one longitudinal end part of the circuit board 14. The I/F connector 57 has a connector body 57a in the form of an elongate, flat, rectangular parallelepiped and a large number of connection terminals 57b extending from the connector body. Further, the connector 57 has a lock lever 57c that locks, for example, an FPC 75, which is connected to the connector 57, in a connected state. The lock lever 57c extends along the longitudinal direction of the connector body 57a.

The I/F connector 57 is mounted on the printed circuit board 14 with a part of the connector body 57a dropped in the notch portion 75 of the circuit board. In this state, the connector body 57a is aligned flush with the reverse side of the circuit board 14 and projects on the obverse side of the circuit board on which the electronic components are mounted. Further, the connector body 57a is aligned with the short side of the circuit board. The connection terminals 57b of the I/F connector 57 are connected to a circuit on the obverse side of the printed circuit board 14 and fixed by soldering or the like. The lock lever 57c projects on the reverse side of the circuit board.

A plurality of inspection pad portions 76 are provided on either side of the notch portion 75 on the surface of the printed circuit board 14 so as to be arranged side by side with the I/F connector 57.

As shown in FIGS. 5 and 7, boss portions 79 protrude individually from a plurality of spots of the reverse surface of the base 10. The printed circuit board 14 is located with a part of its surface in contact with the boss portions 79. The connector body 57a of the I/F connector 57 that is mounted on the circuit board 14 engages and is supported by the first, second, and third supporting projection 72a, 72b and 72c on the base 10. An end part of the connector body 57a engages and is supported by the step portion 74a of the projection 74.

The upper surface of the base 10 on which various components are mounted is closed by the top cover 12 that is screwed to the base. As shown in FIGS. 1, 4 and 5, the top cover 12 is in the form of a rectangle corresponding in size to the base 10. It is formed by press-molding a soft magnetic material, e.g., an iron-based material such as a cold-rolled carbon steel sheet, and its peripheral edge portion forms a substantially flat abutting portion 19. The abutting portion 19 of the top cover 12 is formed having through holes 23a, which are situated corresponding individually to the tapped holes 82 of the base 10.

The top cover 12 is screwed to the base 10 with screws 12b threaded into the tapped holes 82 of the base 10 through the through holes 23a, individually. In this state, the respective abutting portions 13 and 19 of the base 10 and the top cover 12 face each other. To improve gastightness, the respective widths of the abutting portions 13 and 19 of the base 10 and the top cover 12 are made larger than the respective plate thicknesses of the base and the top cover.

The gasket 60 for keeping the inside of the base 10 gastight is interposed between the respective abutting portions 13 and 19 of the base and the top cover 12. As shown in FIGS. 3 and 4, the gasket 60 is in the form of a rectangular frame corresponding in shape to the abutting portion 13 of the base 10. The gasket 60 is formed by vertically sandwiching a thin metal or resin sheet between gasket members of, for example, rubber. Positioning protrusions 66 that project toward the base 10 are formed integrally on a plurality of spots of the gasket 60. The gasket 60 is located in a given position relative to the abutting portion 13 of the base 10 with the positioning protrusions 66 fitted individually in the positioning holes 83 in the abutting portion 13. As the top cover 12 is screwed to the base 10 in this state, the gasket 60 is sandwiched between the respective abutting portions 13 and 19 of the base 10 and the cover 12, whereby a space between the abutting portions is sealed gastight.

As shown in FIGS. 1, 2, 4, 5 and 7, the bottom cover 15 that covers the reverse side of the base 10 and the printed circuit board 14 is formed by press-molding a soft magnetic material, e.g., an iron-based material such as a cold-rolled carbon steel sheet (SPCC), and has a substantially rectangular shape corresponding to the base 10. An elongate, rectangular opening 77 that opens in a short side of the bottom cover 15 and extends along the short side is formed at one longitudinal end part of the bottom cover.

With the reverse side of the base 10 and the printed circuit board 14 covered by the bottom cover 15, the opening 77 of the bottom cover is situated overlapping the I/F connector 57 and the inspection pad portions 76 that are mounted on the circuit board 14, whereby these elements are exposed. Thus, the lock lever 57c of the I/F connector can be operated from outside the HDD, and the inspection pad portions 76 can be accessed with ease.

A side wall 94 is formed integrally on each long side of the bottom cover 15. Each side wall 94 extends at right angles to the bottom cover 15, and its extended end part 94a is squarely folded toward the other side wall.

The bottom cover 15 is located overlapping the reverse side of the printed circuit board 14. It is attached to the base 10 and the top cover 12 with the respective extended end parts 94a of the side walls 94 fitted on the upper surface of the abutting portion 19 of the top cover 12. Thus, the opposite side wall portions of the bottom cover 15 are formed having a substantially U-shaped cross section. By simultaneously fittingly holding the respective abutting portions 13 and 19 of the base 10 and the cover 12 by the side wall portions from the outside, the strength of the entire device can be enhanced, and the bottom cover can be fixed without using any screws or dedicated support members. By covering the whole side faces of the HDD by the side walls 94 of the bottom cover 15, at the same time, influences of external magnetic noises and electric fields can be reduced.

According to the HDD constructed in this manner, the I/F connector 57 is mounted by being partially dropped in the notch portion 75 in the printed circuit board 14. Therefore, the thickness of the entire printed circuit board including the I/F connector can be lessened to thin the whole HDD. When the printed circuit board 14 is incorporated in place, moreover, the connector body 57a of the I/F connector 57 engages and is supported by the first, second, and third supporting projection 72a, 72b and 72c on the base 10 and the step portion 74a of the projection 74. If any external force acts on the I/F connector 57 or the printed circuit board 14, therefore, the I/F connector is restrained from changing its position toward the base 10 by the first, second, and third supporting projection 72a, 72b and 72c and the step portion 74a. Thus, distortion of the I/F connector 57 and the printed circuit board 14 and damage to the I/F connector itself can be prevented, so that a junction between the I/F connector and the circuit board can be prevented from being damaged or cracked. In consequence, the strength of the electronic components on the printed circuit board against external force can be enhanced to improve the reliability of the HDD.

According to the present embodiment, there are a plurality of supporting projections, e.g., three in number, and they individually engage the central part and opposite end parts of the connector body 57a. Further, the step portion 74a is provided on a convexity to which another component, i.e., the air filter 28 in this case, on the base 10 is attached, and this step portion is also used as a supporting projection for connector support. Thus, the entire I/F connector 57 can be steadily supported, and the strength against external force can be enhanced further.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

For example, the supporting projections of the base that support the electronic component are not limited to three in number but may be increased or reduced in number as required. The size and shape of each supporting projection may be modified depending on the type of the electronic component to be supported thereon. According to the foregoing embodiment, the I/F connector, among other electronic components mounted on the printed circuit board 14, is drop-mounted and supported by the supporting projections of the base. However, any other electronic components than the I/F connector may be also drop-mounted and supported by the supporting projections. Further, the bottom cover may be omitted depending on the type of the device. The magnetic disk is not limited to one in number, and more magnetic disks may be used, if necessary. Furthermore, the material of the base and the top and bottom covers is not limited to a cold-rolling carbon steel sheet but may be any other soft magnetic material.

What is claimed is:

1. A disk device comprising:
a base;
a disk-shaped recording medium provided on the base;
a mechanical section provided on the base and including a head which processes information on the recording medium, a head actuator supporting the head, and a drive motor which supports and rotates the recording medium; and
a printed circuit board which is provided opposite the base on a reverse side thereof and has a notch portion and an electronic component mounted in the notch portion by being at least partially dropped therein,
the base having a projection which projects on the printed circuit board side and engages and supports the electronic component.

2. A disk device according to claim 1, wherein the base has a plurality of boss portions which project on the printed circuit board side and engage the printed circuit board.

3. A disk device according to claim 1, which further comprises a plate-like bottom cover which is provided on the reverse side of the printed circuit board and covers the reverse side of the printed circuit board and the base.

4. A disk device according to claim 3, wherein the printed circuit board has a plurality of pad portions provided side by side with the notch portion, and the bottom cover has an opening through which the electronic component mounted in the notch portion and the pad portions are exposed.

5. A disk device according to claim 3, wherein the base has a top opening and a pair of side edge portions extending parallel to each other, and which further comprising a top cover which is attached to the base and covers the top opening of the base, the recording medium, and the mechanical section,
the top cover has a pair of side edge portions individually overlapping the side edge portions and extending parallel to each other, and the bottom cover has a pair of side walls which simultaneously fittingly hold the respective side edge portions of the base and the top cover from the outside.

6. A disk device according to claim 1, wherein the electronic component is a connector configured to be connected to an external device, and the projection of the base includes a plurality of supporting projections arranged side by side with gaps therebetween in a longitudinal direction of the connector and in contact with the connector.

7. A disk device according to claim 6, which further comprises an air filter provided on the base, and wherein the base has a recess which projects on the printed circuit board side and houses a part of the air filter, a part of the recess having a step portion which forms the supporting projection.
